(19) United States
(12) Patent Application Publication
(10) Pub. No.: US 2019/0164233 A1
(43) Pub. Date: May 30, 2019

(54) APPARATUS AND METHOD FOR MATCHING MEMBERS OF CARPOOL

(71) Applicants: Hyundai Motor Company, Seoul (KR); Kia Motors Corporation, Seoul (KR)

(72) Inventors: Yarygina Anastasia, Seoul (KR); Jimin Han, Gyeonggi-do (KR); Jung Mi Park, Gyeonggi-do (KR); Jia Lee, Gyeonggi-do (KR)

(21) Appl. No.: 16/101,466

(22) Filed: Aug. 12, 2018

(30) Foreign Application Priority Data
Nov. 27, 2017 (KR) 10-2017-0159490

(51) Int. Cl. G06Q 50/00; H04L 29/08; H04W 4/02; G06Q 50/30

(52) U.S. Cl. CPC G06Q 50/01; H04L 67/306; G01C 21/3438; G06Q 50/30; H04W 4/023

(57) ABSTRACT

An apparatus for matching members of a carpool service is provided. The apparatus includes a communication circuit that is configured to communicate with an external device and a processor that is electrically connected with the communication circuit. The processor is configured to receive an answer to a plurality of indirect questionnaires from a user terminal using the communication circuit and determine a characteristic of a first user based on the answer. Additionally, the processor is configured to determine whether to match the first user with a second user based on the user characteristic, when generating a user group to share a vehicle.

### CROSS-REFERENCE TO RELATED APPLICATION

This application is based on and claims the benefit of priority to Korean Patent Application No. 10-2017-0159490, filed on Nov. 27, 2017, the disclosure of which is incorporated herein in its entirety by reference.

### TECHNICAL FIELD

The present disclosure relates to an apparatus and method for matching members of a carpool using a variety of information, and more particularly, to an apparatus and method for matching members of a carpool using an indirect questionnaire based on statistics and avoiding a match between users who have a mismatched tendency using the estimated result.

### BACKGROUND

Recently, there has been a growing interest in a service (hereinafter referred to as “mobility service” for convenience of description), such as car sharing, a carpool, or car hailing, which may use vehicles of service providers or vehicles of personal owners. The mobility service may be provided through a service provider server and a personal device of a user. For example, the user may input information about a desired trip using the mobility service and may share a vehicle matched with the input information. The mobility service may be for providing a service of matching a driver with one or more passengers depending on a trip input by the user.

In connection with the mobility service, in the related art, there has been research and development for a method for minimizing costs or optimizing a movement path. However, a provider of the mobility service may have an interest in providing comfortable, safe matching to the user. Particularly, there may be a need for a method for preventing another user who has a negative influence on the first user or has a characteristic avoided by the first user from being matched with the first user. There may be a need for developing an apparatus and method for finding out a negative characteristic without hostility of the user.

### SUMMARY

The present disclosure provides an apparatus and method for estimating a tendency of a user using an indirect questionnaire based on statistics and avoiding a match between users who have a mismatched tendency using the estimated result. The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, an apparatus for matching members of a carpool may include: a communication circuit configured to communicate with an external device and a processor configured to be electrically connected with the communication circuit. The processor may be configured to receive an answer to a plurality of indirect questionnaires from a terminal of a user using the communication circuit, determine a characteristic of the user based on the answer, and determine whether to match the user with another user based on the characteristic of the user, when generating a user group to share a vehicle.

In an exemplary embodiment, the plurality of indirect questionnaires may include a questionnaire for obtaining information associated with at least one of smoking, an allergy, a noise, flu, a respiratory disease, and a probability of drinking. In addition, the processor may be configured to determine the characteristic of the user based on the answer and a residence location of the user. The processor may then be configured to determine the characteristic of the user based on the answer and a social media profile of the user.

In an exemplary embodiment, the processor may be configured to determine the characteristic of the user by statistically analyzing the answer to the plurality of indirect questionnaires. The processor may be configured to generate a profile of the user which indicates the characteristic of the user. When a matching request is received from the terminal of the user, the processor may be configured to determine whether to match the user with the other user based on a profile of the user and a recently visited location of the user.

In addition, when a matching request is received from the terminal of the user, the processor may be configured to determine whether to match the user with the other user based on a profile of the user and a pick-up location of the user. The processor may then be configured to determine a characteristic of the other user based on an answer to the plurality of indirect questionnaires, the answer being received from a terminal of the other user and predict whether the user will avoid the other user based on the characteristic of the user and the characteristic of the other user.

Further, the processor may be configured to determine a characteristic of the other user based on an answer to the plurality of indirect questionnaires, the answer being received from a terminal of the other user and predict whether the other user will avoid the user based on the characteristic of the user and the characteristic of the other user. The processor may be configured to determine a characteristic of the other user based on an answer to the plurality of indirect questionnaires, the answer being received from a terminal of the other user and calculate a score that indicates a match suitability between the user and the other user, based on the characteristic of the user and the characteristic of the other user.

According to another aspect of the present disclosure, a method for matching members of a carpool may include: receiving an answer to a plurality of indirect questionnaires from a terminal of a user, determining a characteristic of the user based on the answer, and determining whether to match the user with another user based on the characteristic of the user, when generating a user group to share a vehicle.

In an exemplary embodiment, the characteristic of the user may be determined based on the answer and a location of a residence of the user. In addition, the characteristic of the user may be determined based on the answer and a social media profile of the user. The determination may further include determining the characteristic of the user by statistically analyzing the answer to the plurality of indirect questionnaires. When a matching request is received from the terminal of the user, the method may include determining whether to match the user with the other user based on a profile of the user and a recently visited place of the user.

Additionally, when a matching request is received from the terminal of the user, the method may include determining whether to match the user with the other user based on a profile of the user and a pick-up location of the user. The method may further include determining a characteristic of the other user based on an answer to the plurality of indirect questionnaires, the answer being received from a terminal of the other user. The method may also include predicting whether the user will avoid the other user based on the characteristic of the user and the characteristic of the other user.

In an exemplary embodiment, the method may further include determining a characteristic of the other user based on an answer to the plurality of indirect questionnaires, the answer being received from a terminal of the other user. The determination may further include predicting whether the other user will avoid the user based on the characteristic of the user and the characteristic of the other user.

According to another aspect of the present disclosure, an apparatus for matching members of a carpool may include: a communication circuit configured to communicate with an external device and a processor configured to be electrically connected with the communication circuit. The processor may be configured to receive an answer to a plurality of indirect questionnaires from a terminal of a user using the communication circuit, generate a user profile indicating a characteristic of the user by statistically analyzing the answer, a residence location of the user, and a social media profile of the user, and, when a matching request is received from the terminal of the user, determine whether to match the user with another user based on at least part of a recently visited location of the user or a pick-up location of the user and the user profile.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a configuration of an apparatus for matching members of a carpool according to an exemplary embodiment of the present disclosure;

FIG. 2 is a block diagram illustrating exemplary data used and generated by an apparatus for matching members of a carpool according to an exemplary embodiment of the present disclosure;

FIG. 3 is a drawing illustrating information inferable from exemplary data used by an apparatus for matching members of a carpool according to an exemplary embodiment of the present disclosure;

FIG. 4 is a drawing illustrating an exemplary factor used by an apparatus for matching members of a carpool according to an exemplary embodiment of the present disclosure;

FIG. 5 is a drawing illustrating an exemplary questionnaire used by an apparatus for matching members of a carpool according to an exemplary embodiment of the present disclosure;

FIG. 6 is a drawing illustrating an exemplary operation of an apparatus for matching members of a carpool according to an exemplary embodiment of the present disclosure;

FIG. 7 is a drawing illustrating an exemplary operation of an apparatus for matching members of a carpool according to an exemplary embodiment of the present disclosure;

FIG. 8 is a flowchart illustrating a method for matching members of a carpool according to an exemplary embodiment of the present disclosure; and

FIG. 9 is a block diagram illustrating a configuration of a computing system according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present disclosure will be described in detail with reference to the accompanying drawings. In adding reference denotations to elements of each drawing, although the same elements are displayed on a different drawing, it should be noted that the same elements have the same denotations. In addition, in describing an embodiment of the present disclosure, if it is determined that a detailed description of related well-known configurations or functions blurs the gist of an embodiment of the present disclosure, it will be omitted.

In describing elements of embodiments of the present disclosure, the terms 1^{st}, 2^{nd}, first, second, A, B, (a), (b), and the like may be used herein. These terms are only used to distinguish one element from another element, but do not limit the corresponding elements irrespective of the nature, turn, or order of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

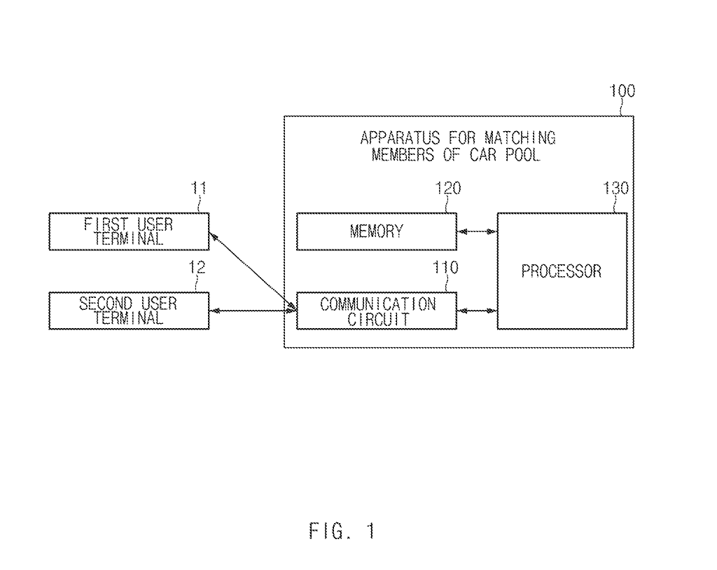

FIG. 1 is a block diagram illustrating a configuration of an apparatus for matching members of a carpool according to an exemplary embodiment of the present disclosure.

Referring to FIG. 1, an apparatus 100 for matching members of a carpool according to an exemplary embodiment (hereinafter referred to as “apparatus 100” for convenience of description) may include a communication circuit 110, a memory 120, and a processor 130. The apparatus 100 may be, for example, a server configured to provide a mobility service to a plurality of users.

The communication circuit 110 may be configured to communicate with an external terminal. The communication circuit 110 may be connected with, for example, the external terminal by various types of wired and wireless communication. The communication circuit 110 may be configured to communicate with a first user terminal 11 and a second user terminal 12. In FIG. 1, an exemplary embodiment is exemplified as the communication circuit 110 communicates with the two user terminals 11 and 12. However, exemplary embodiments are not limited thereto. For example, the communication circuit 110 may be configured to communicate with any number of user terminals.

The memory 120 may include a volatile memory and/or a non-volatile memory. The memory 120 may be configured to store a variety of data and information used by an element of the apparatus 100. The memory 120 may be configured to store instructions and/or a database for executing operations performed by the processor 130. The processor 130 may be electrically connected with the communication circuit 110 and the memory 120. The processor 130 may be configured to operate the communication circuit 110 and the memory 120 and perform a variety of data processing and various arithmetic operations.

According to an exemplary embodiment, the processor 130 may be configured to receive an answer to a plurality of indirect questionnaires via the communication circuit 110 from a terminal of a user (e.g., from a first user). The plurality of indirect questionnaires may include a questionnaire for estimating a characteristic having a probability of being avoided by a user or another user, that is, a first user and a second user (e.g., information associated with health). The plurality of indirect questionnaires may include a questionnaire for estimating a characteristic of the user in a social-demographic method without including a questionnaire for directly inquiring of the user regarding the characteristic. The plurality of indirect questionnaires may include a questionnaire for obtaining information associated with at least one of, for example, smoking of the user, an allergy of the user, a noise of the user, flu of the user, a respiratory disease of the user, and a probability that the user will drink. The plurality of indirect questionnaires may be stored in the memory 120. The processor 130 may then be configured to provide the plurality of indirect questionnaires to a user terminal using the communication circuit 110 and may be configured to receive an answer to a questionnaire input by the user from the user terminal using the communication circuit 110.

According to an exemplary embodiment, the processor 130 may be configured to determine a characteristic of the user based on an answer to the plurality of indirect questionnaires. The processor 130 may be configured to determine a characteristic of the user based on a residence location of the user, a social media profile of the user, and/or like together with the answer. The characteristic of the user may include information that indicates whether the user has a negative characteristic or whether the user has a tendency to avoid the negative characteristic. For example, the characteristic of the user may include information that indicates whether the user is a smoker, has an allergic factor (e.g., to a fur of a pet), is sensitive or insensitive to a noise, is sick (e.g., has the flu, a cold, or the like), has a respiratory disease, a drinking probability, and/or the like.

As another example, the characteristic of the user may include information that indicates whether the user has a tendency to avoid a smoker, avoid an allergic factor, be sensitive to a noise, avoid a flu patient, avoid a patient with a respiratory disease, be sensitive to a smell of alcohol, and/or the like. In other words, the above characteristic may refer situations (e.g., smoking, sickness, etc.) that a vehicle user prefers to avoid when sharing a vehicle with another user. Further, the processor 130 may be configured to determine a characteristic of the user by statistically analyzing an answer to the plurality of indirect questionnaires, a residence location of the user, and/or a social media profile of the user. The processor 130 may then be configured to analyze the answer to the plurality of indirect questionnaires, the residence location of the user, and/or the social media profile of the user in a social-demographic method. The processor 130 may be configured to predict whether there is a high probability that the user will have a specific characteristic, through the analysis.

According to an exemplary embodiment, the processor 130 may then be configured to generate a profile of the user that indicates a characteristic of the user. The processor 130 may be configured to generate a user profile including information that indicates whether the user has a negative characteristic or avoids the negative characteristic. The user profile may be stored in the memory 120.

Accordingly, when generating a user group to share a vehicle, the processor 130 may be configured to determine whether to match a first user with a second user based on a characteristic of the first user. When a matching request is received from a terminal of the first user, the processor 130 may be configured to determine whether to match the first user with the second user using additional information together with the user profile. The additional information may include, for example, a recently visited location of the user and/or a pick-up location of the user. Accuracy of prediction may be enhanced by using the additional information. For example, when a recently visited location and/or a pick-up location of a user who has a high probability of drinking in a user profile is an adult entertainment district, a match between the user and a user who is sensitive to a smell of alcohol may be avoided at a higher probability.

Furthermore, the processor 130 may be configured to calculate a probability of a mismatch between users using a negative characteristic of the user and may avoid a match between the mismatched users, thus improving matching between the users. Accordingly, user satisfaction is also improved which thus increases the user of vehicle sharing programs. For example, the processor 130 may be configured to determine a characteristic of a first user based on an answer to the plurality of indirect questionnaires received from the first user terminal 11 and may then be configured to predict whether a second user avoids the first user and whether the first user avoids the second user, based on a characteristic of the first user and a characteristic of the second user. The processor 130 may be configured to determine a characteristic of a second user based on an answer to a plurality of indirect questionnaires received from a terminal of a second terminal and may be configured to calculate a score that indicates a match suitability between a user and the other user based on a characteristic of the user and a characteristic of the other user.

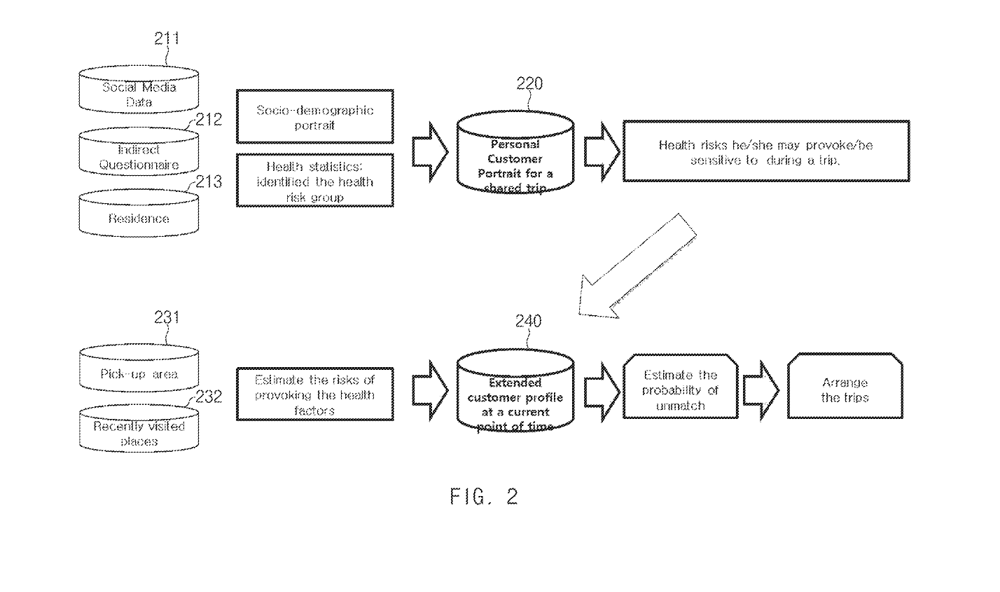

FIG. 2 is a block diagram illustrating exemplary data used and generated by an apparatus for matching members of a carpool according to an exemplary embodiment of the present disclosure. Referring to FIG. 2, an apparatus according to an exemplary embodiment may be configured to generate a user profile 220 using a social media data 211, an indirect questionnaire 212, and residence information 213. For example, the apparatus may be configured to predict a socio-demographic portrait and predict a health risk group.

Further, the apparatus may be configured to determine a characteristic of provoking a user or a characteristic in which the user may provoke another user, during a trip based on the user profile 220. The apparatus may be configured to generate an extended user profile 240 based on a pick-up area 231, a recently visited location 232, and the user profile 220. For example, the apparatus may be configured to estimate the risk of provoking the user based on the pick-up area 231, the recently visited location 232, and the user profile 220 and may be configured to generate the extended user profile 240 using the estimated result. The apparatus may then be configured to predict a probability of a mismatch using the extended user profile 240 and may arrange trips accordingly to thus increase user satisfaction.

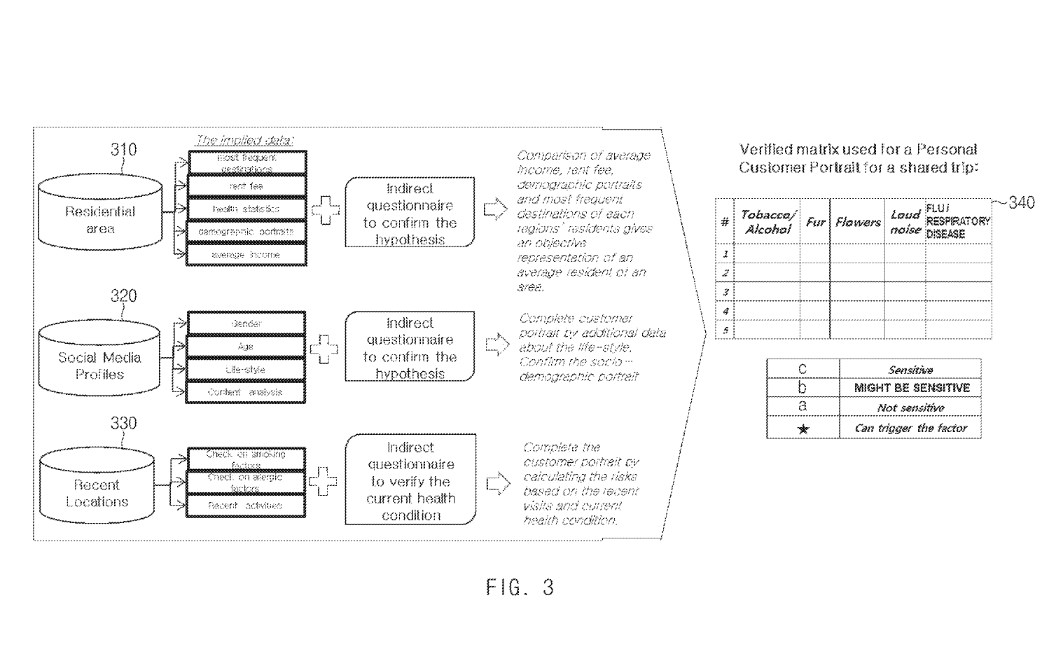

FIG. 3 is a drawing illustrating information inferable from exemplary data used by an apparatus for matching members of a carpool according to an exemplary embodiment of the present disclosure. Referring to FIG. 3, an apparatus according to an exemplary embodiment may be configured to predict a user characteristic using a residential area 310, a social media profile 320, a recent location 330, and the like. For example, the residential area 310 may imply information regarding a most frequent destination, a rent fee, health statistics, a socio-demographic portrait, an average income, and the like. The apparatus may be configured to predict the most frequent destination, the rent fee, the health statistics, the socio-demographic portrait, the average income, and the like based on the residential area 310 and an answer to an indirect questionnaire.

As another example, the social media profile 320 may imply information regarding a gender, an age, a life-style, preferred content, and the like. The apparatus may be configured to predict a life-style, a socio-demographic portrait, and the like based on the social media profile 320 and an answer to an indirect questionnaire. As another example, the recent location 330 may imply information regarding smoking, an allergic factor, recent activities, and the like. The apparatus may be configured to predict whether a user smokes, whether the user is exposed to an allergic factor, recent activities, and the like based on the recent location 330 and an answer to an indirect questionnaire. The apparatus may then be configured to calculate sensitivity to tobacco/alcohol, fur, a flower, a loud noise, and a flu/respiratory disease based on the predicted result. The apparatus may then be configured to generate a user profile that includes the sensitivity information. The apparatus may be configured to perform scoring for each of (c) when a user is sensitive to a specific characteristic, (b) when the user might be sensitive to the specific characteristic, (a) when the user is not sensitive to the specific characteristic, and (★) when the user has the specific characteristic and may then be configured to generate a user profile in which a score is reflected.

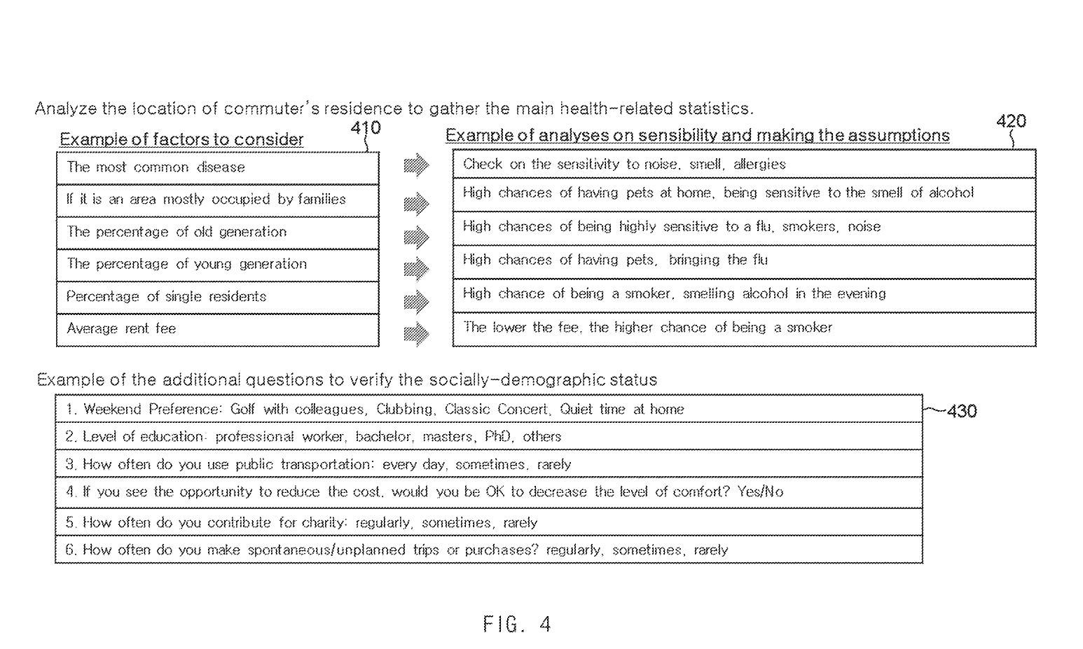

FIG. 4 is a drawing illustrating an exemplary factor used by an apparatus for matching members of a carpool according to an exemplary embodiment of the present disclosure. Referring to FIG. 4, an apparatus according to an exemplary embodiment may obtain various factors 410 to consider from residence information of a user. For example, the apparatus may be configured to obtain information that indicates a common disease, whether it is an area mostly occupied by families, a percentage of an older generation in that area, a percentage of a younger generation in that area, a percentage of single residents, and an average rent feed, as the factors 410 to consider. The apparatus may then be configured to predict an analysis result 420 from each of the factors 410 to consider.

For example, the apparatus may be configured to analyze the information regarding the common disease to predict sensitivity to a noise, a smell, and an allergy. The apparatus may be configured to analyze the information indicating whether the area is mostly occupied by the families to predict a chance of having a pet and sensitivity to a smell of alcohol. The apparatus may be configured to predict sensitivity to flu, a smoker, and a noise based on the information regarding the percentage of an older generation. The apparatus may be configured to predict a chance of having a pet and a chance of the flu based on the information regarding the percentage of a younger generation. The apparatus may be configured to predict a chance of being a smoker and a chance of smelling alcohol in the evening based on the information regarding the percentage of single residents. The apparatus may be configured to predict a chance of being a smoker based on the information regarding the average rent fee. However, the above prediction are merely exemplary and any combination or factors or characteristics may be used.

Furthermore, the apparatus may improve accuracy of the analysis result 420 using an additional question 430. For example, the apparatus may improve the accuracy of the analysis result 420 using the additional question 430 for inquiring about weekend preference, a level of education, “how often do you use public transportation?”, whether the user would approve to decrease the level of comfort if you see the opportunity to reduce the cost, “how often do you contribute for charity?”, and “how often do you make spontaneous/unplanned trips or purchases?”.

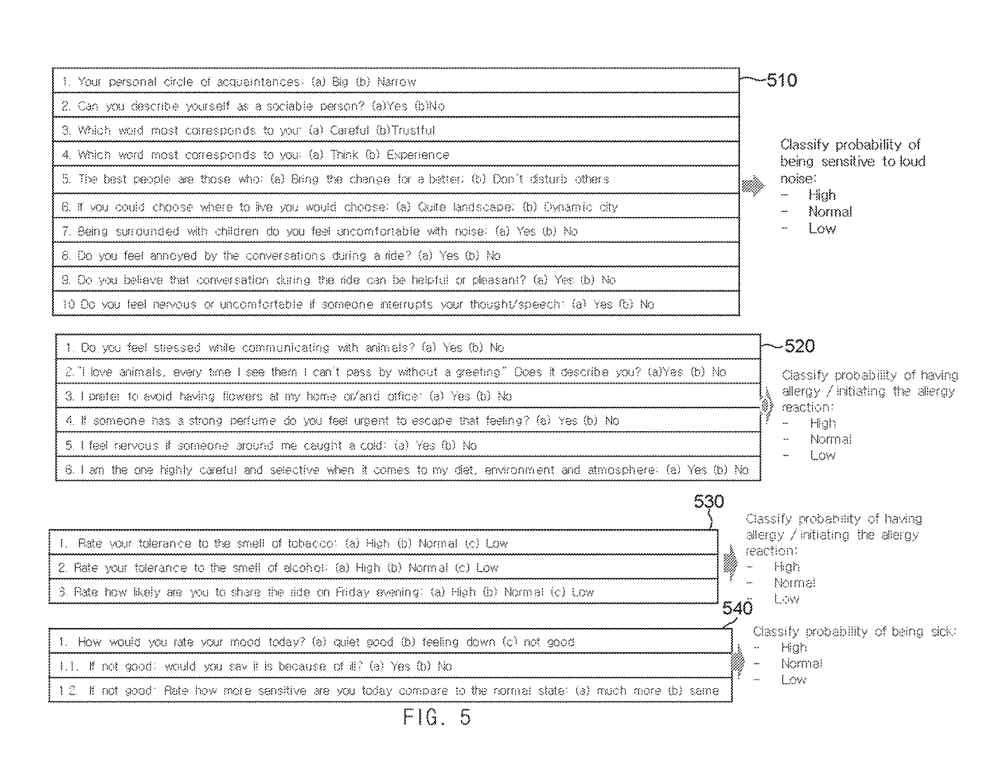

FIG. 5 is a drawing illustrating an exemplary questionnaire used by an apparatus for matching members of a carpool according to an exemplary embodiment of the present disclosure. Referring to FIG. 5, an apparatus according to an exemplary embodiment may use a plurality of indirect questions for determining sensitivity to a noise, a chance of having an allergy, sensitivity to tobacco/alcohol, a probability of being sick, and the like. A questionnaire 510 associated with a noise may include, for example, questions about your personal circle of acquaintances, “can you describe yourself as a sociable person?”, “which word most corresponds to you”, and the like.

A questionnaire 520 associated with an allergy may include, for example, questions about whether you feel stressed while communicating with animals, whether the user prefers to avoid having flowers, whether the user dislikes a strong perfume, and the like. A questionnaire 530 associated with tobacco/alcohol may include, for example, a degree of tolerance to the smell of tobacco, a degree of tolerance to the smell of alcohol, a probability of sharing the ride on a Friday evening. A questionnaire 540 associated with disease may include, for example, questions about personal mood, a cause of the mood, and the like. The apparatus may then be configured to determine sensitivity to a noise, a chance of having an allergy, sensitivity to tobacco/alcohol, a probability of being sick, and the like.

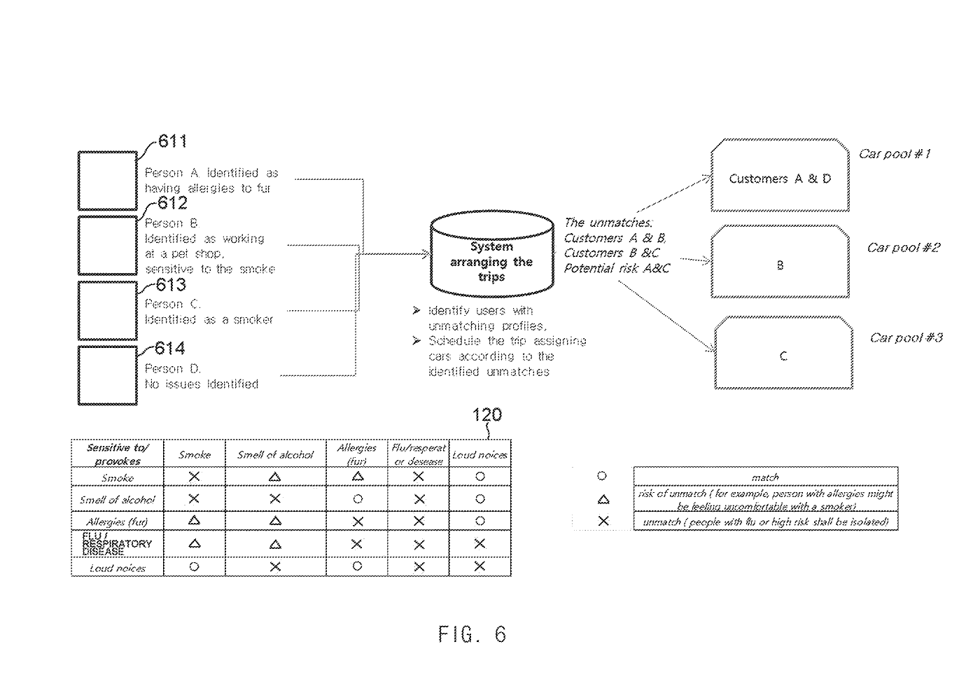

FIG. 6 is a drawing illustrating an exemplary operation of an apparatus for matching members of a carpool according to an exemplary embodiment of the present disclosure. Referring to FIG. 6, an apparatus according to an exemplary embodiment may obtain information about user A 611, user B 612, user C 613, and user D 614. User A 611 may be identified as having allergies to fur, and user B 612 may be identified as working at a pet shop and being sensitive to smoking. User C 613 may be identified as a smoker, and user D 614 may be identified as having no issues. The apparatus may be configured to group at least some of users based on characteristics of user A 611, user B 612, user C 613, and user D 614.

For example, user A 611 having allergies to fur and user B 612 who works at a pet shop may fail to be matched. User B 612 who is sensitive to smoking and user C 613 who is a smoker may fail to be matched. Further, there may be a high probability that user A 611 having allergies will avoid user C 613 who is a smoker. The apparatus may then be configured to separate mismatched users from users having a high probability of being mismatched. The apparatus may be configured to group user A 611 and user D 614, avoid to group user B 612, and avoid to group user C 613.

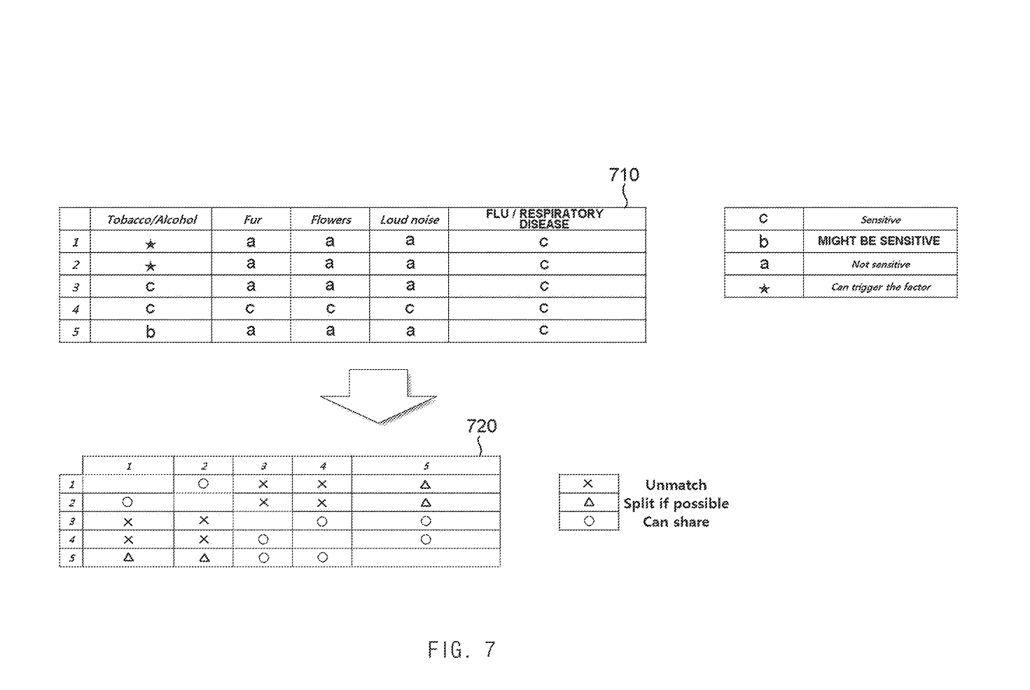

FIG. 7 is a drawing illustrating an exemplary operation of an apparatus for matching members of a carpool according to an exemplary embodiment of the present disclosure. These characteristics listed below are merely exemplary and the present disclosure is not limited thereto. Referring to FIG. 7, an apparatus according to an exemplary embodiment may score sensitivity of a user to a characteristic. A first table 710 may include scores that indicate a sensitivity to tobacco/alcohol, fur, flowers, a loud noise, and a flu/respiratory disease of each of a first user, a second user, a third user, a fourth user, and a fifth user. The apparatus may be configured to generate a score for each of the following scenarios: (c) when a user is sensitive to a specific characteristic, (b) when there is a probability that the user will be sensitive the specific characteristic, (a) when the user is not sensitive to the specific characteristic, and (★) when the user has the specific characteristic.

For example, the first user and the second user may have characteristics in which they enjoy tobacco/alcohol, in which they are not sensitive to fur, flowers, and a loud noise, and in which they are sensitive to a flu/respiratory disease. The third user may have characteristics of being sensitive to tobacco/alcohol, not sensitive to fur, flowers, and a loud noise, and sensitive to a flu/respiratory disease. The fourth user may have characteristics of being sensitive to tobacco/alcohol, fur, flowers, a loud noise, and a flu/respiratory disease. The fifth user may have characteristics of being sensitive to tobacco/alcohol, not sensitive to fur, flowers, and a loud noise, and sensitive to a flu/respiratory disease.

Accordingly, the apparatus may be configured to determine a probability of matching users based on scores of sensitivity. A second table 720 may include scores that indicate a probability of matching the first user, the second user, the third user, the fourth user, and the fifth user. The apparatus may be configured to generate a score for each of the following scenarios: (O) when it is possible to match users with each other, (Δ) when the users should be split, and (x) when the users are mismatched with each other.

For example, the third user and the fourth user who are sensitive to tobacco/alcohol may be mismatched with the first user and the fourth user who enjoy tobacco/alcohol. The first user and the second user who enjoy tobacco/alcohol may be matched with each other. The fifth user who has a probability of being sensitive to tobacco/alcohol may split from the first user and the second user, if possible. The apparatus may be configured to match or split the users using the second table 720.

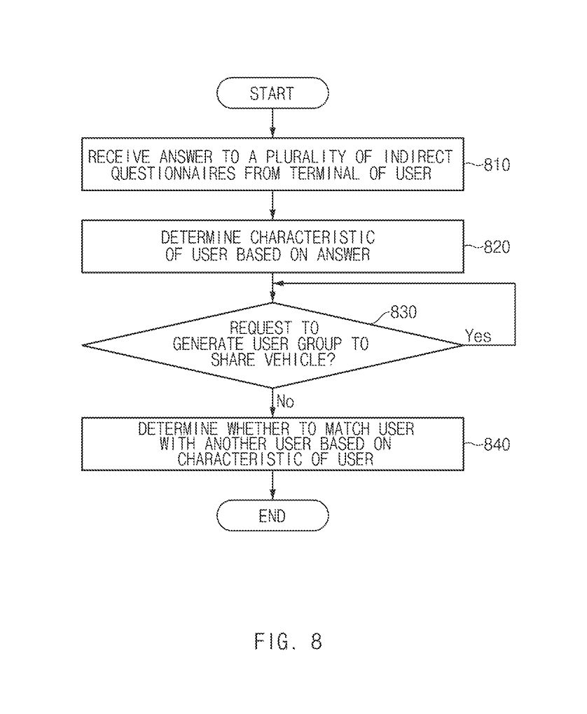

FIG. 8 is a flowchart illustrating a method for matching members of a carpool according to an exemplary embodiment of the present disclosure. Hereinafter, it may be assumed that an apparatus 100 of FIG. 1 performs a process of FIG. 8. Further, in a description of FIG. 8, an operation described as being performed by an apparatus may be understood as being executed by a processor 130 of the apparatus 100. Referring to FIG. 8, in operation 810, the apparatus may be configured to receive an answer to a plurality of indirect questionnaires from a user terminal. For example, the apparatus may be configured to provide the plurality of indirect questionnaires to the user terminal and receive an answer by a user input from the user terminal.

In operation 820, the apparatus may be configured to determine a characteristic of the user based on the received answer. For example, the apparatus may be configured to determine the characteristic of the user by analyzing the answer in a socio-demographic method. In addition, the apparatus may be configured to use a residence of the user, a social media profile of the user, and/or the like to determine the characteristic. In operation 830, the apparatus may be configured to determine whether there is a request to generate a user group to share a vehicle. For example, the apparatus may be configured to receive a carpool request from the user terminal.

In response to receiving the carpool request, in operation 840, the apparatus may be configured to determine whether to match the first user with a second user based on the characteristic of the first user. For example, the apparatus may be configured to calculate a probability of a mismatch between users using a negative characteristic of the first user, may avoid a match between mismatched users, and may match the first user with the second user. In addition, the apparatus may consider a recently visited location, a pick-up location, and/or the like of the first user to determine whether to match the users. Lastly, the apparatus may be configured to generate a user group to be executed by the vehicle for the carpooling.

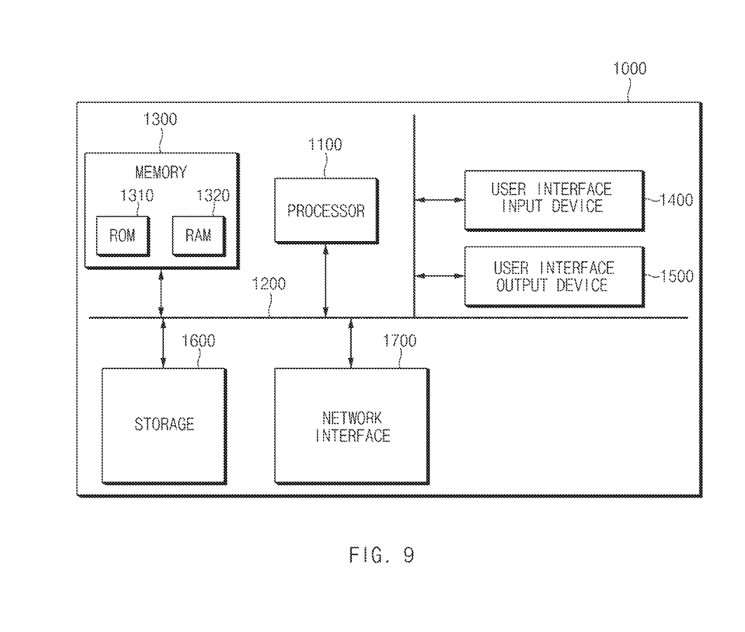

FIG. 9 is a block diagram illustrating a configuration of a computing system according to an exemplary embodiment of the present disclosure. Referring to FIG. 9, the user input processing method according to an exemplary embodiment of the present disclosure may be implemented using the computing system. A computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device configured to execute processing of instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the exemplary embodiments disclosed in the specification may be directly implemented with a hardware module, a software module, or combinations thereof, executed by the processor 1100. The software module may reside on a storage medium (i.e., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM). An exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as a separate component of the user terminal.

The apparatus and method for matching members of a carpool may provide a comfortable, secure mobility service by estimating a characteristic of the user using indirect information, such as an indirect questionnaire, a residence, a social media profile, a recently visited location, and a pick-up location, and preventing users having a mismatched characteristic from being matched with each other. In addition, various effects indirectly or directly ascertained through the present disclosure may be provided.

While the present disclosure has been described with reference to exemplary embodiments, it will be apparent to those skilled in the art that various changes and modifications may be made without departing from the spirit and scope of the present disclosure. Therefore, exemplary embodiments of the present disclosure are not limiting, but illustrative, and the spirit and scope of the present disclosure is not limited thereto. The spirit and scope and the present disclosure should be interpreted by the following claims, it should be interpreted that all technical ideas which are equivalent to the present disclosure are included in the spirit and scope of the present disclosure.

What is claimed is:

1. An apparatus for matching members of a carpool service, comprising:
a communication circuit configured to communicate with an external device; and
a processor configured to be electrically connected with the communication circuit,
wherein the processor is configured to:
receive an answer to a plurality of indirect questionnaires from a first user terminal using the communication circuit;
determine a characteristic of a first user based on the answer; and
determine whether to match the first user with a second user based on the determined characteristic, when generating a user group to share a vehicle.

2. The apparatus of claim 1, wherein the plurality of indirect questionnaires include a questionnaire for obtaining information associated with at least one selected from the group consisting of: smoking, an allergy, a noise, flu, a respiratory disease, and a probability of drinking.

3. The apparatus of claim 1, wherein the processor is configured to:
determine the characteristic of the first user based on the received answer and a location of a residence of the first user.

4. The apparatus of claim 1, wherein the processor is configured to:
determine the characteristic of the first user based on the received answer and a social media profile of the first user.

5. The apparatus of claim 1, wherein the processor is configured to:
determine the characteristic of the first user by statistically analyzing the received answer.

6. The apparatus of claim 1, wherein the processor is configured to:
generate a profile of the first user that indicates the characteristic of the first user.

7. The apparatus of claim 1, wherein when a matching request is received from the first user terminal, the processor is configured to determine whether to match the first user with the second user based on a profile of the first user and a recently visited location of the first user.

8. The apparatus of claim 1, wherein when a matching request is received from the first user terminal, the processor is configured to determine whether to match the first user with the second user based on a profile of the first user and a pick-up location of the first user.

9. The apparatus of claim 1, wherein the processor is configured to:
determine a characteristic of the second user based on an answer to the plurality of indirect questionnaires, received from a second user terminal; and
predict whether the first user avoids the second user based on the characteristic of the first user and the characteristic of the second user.

10. The apparatus of claim 1, wherein the processor is configured to:
determine a characteristic of the second user based on an answer to the plurality of indirect questionnaires, received from a second terminal; and
predict whether the second user avoids the first user based on the characteristic of the first user and the characteristic of the second user.

11. The apparatus of claim 1, wherein the processor is configured to:
determine a characteristic of the second user based on an answer to the plurality of indirect questionnaires, received from a second terminal; and
calculate a score that indicates a match suitability between the first user and the second user, based on the characteristic of the first user and the characteristic of the second user.

12. A method for matching members of a carpool service, comprising:
receiving, by a processor, an answer to a plurality of indirect questionnaires from a first user terminal;
determining, by the processor, a characteristic of a first user based on the received answer; and
determining, by the processor, whether to match the first user with a second user based on the characteristic of the first user, when generating a user group to share a vehicle.

13. The method of claim 12, wherein the determining of the characteristic includes:
determining, by the processor, the characteristic of the first user based on the received answer and a residence location of the first user.

14. The method of claim 12, wherein the determining of the characteristic includes:
determining, by the processor, the characteristic of the first user based on the received answer and a social media profile of the first user.

15. The method of claim 12, wherein the determining of the characteristic includes:
determining, by the processor, the characteristic of the first user by statistically analyzing the received answer.

16. The method of claim 12, wherein the determining of whether to match the first user and the second user includes:
determining, by the processor, whether to match the first user with the second user based on a profile of the first user and a recently visited location of the first user when a matching request is received from the first user terminal.

17. The method of claim 12, wherein the determining of whether to match the first user and the second user includes:
determining, by the processor, whether to match the first user with the second user based on a profile of the first user and a pick-up location of the first user when a matching request is received from the first user terminals.

18. The method of claim 12, further comprising:
determining, by the processor, a characteristic of the second user based on an answer to the plurality of indirect questionnaires, received from a second user terminal,
wherein the determining of the characteristic of the second user includes:
predicting, by the processor, whether the first user avoids the second user based on the characteristic of the first user and the characteristic of the second user.

19. The method of claim 12, further comprising:
determining, by the processor, a characteristic of the second user based on an answer to the plurality of indirect questionnaires, received from a second user terminal,
wherein the determining of the characteristic of the second user includes:
predicting, by the processor, whether the second user avoids the first user based on the characteristic of the first user and the characteristic of the second user.

20. An apparatus for matching members of a carpool service, comprising:
a communication circuit configured to communicate with an external device; and
a processor configured to be electrically connected with the communication circuit,
wherein the processor is configured to:
receive an answer to a plurality of indirect questionnaires from a user terminal using the communication circuit;
generate a user profile that indicates a characteristic of a first user by statistically analyzing the received answer, a residence location of the first user, and a social media profile of the first user; and
in response to receiving a matching request is received from the user terminal of the user, determine whether to match the first user with a second user based on at least part of a recently visited place of the first user or a pick-up location of the first user and the first user profile.
